(19) United States
(12) Patent Application Publication
(10) Pub. No.: US 2012/0145542 A1
(43) Pub. Date: Jun. 14, 2012

(54) SENSITIVE MEMBRANE FOR ION SELECTIVE ELECTRODE

(75) Inventors: Yoshiaki Nakamura, Kanagawa (JP); Hirohisa Miyamoto, Kanagawa (JP)

(73) Assignee: KABUSHIKI KAISHA TOSHIBA, Tokyo (JP)

(21) Appl. No.: 13/347,765

(22) Filed: Jan. 11, 2012

Related U.S. Application Data
(63) Continuation-in-part of application No. PCT/JP2009/003281, filed on Jul. 14, 2009.

(51) Int. Cl. G01N 27/26

(52) U.S. Cl. 204/415

(57) ABSTRACT

A sensitive membrane for an ion selective electrode selectively responsive to Na+ ion, the sensitive membrane having an ionophore,, an anion exclusion agent, a plasticizer and a membrane matrix, wherein the amount of the ionophore is from 85 wt % to 95 wt % based on the mixed amount of the ionophore and the anion exclusion agent.

### CROSS-REFERENCE TO RELATED APPLICATION

This application is a continuation-in-part (CIP) application based upon the International Application PCT/JP2009/003281, the International Filing Date of which is Jul. 14, 2009, the entire content of which is incorporated herein by reference.

### FIELD

The present invention relates to a sensitive membrane for an ion selective electrode.

### BACKGROUND

As a method for measuring electrolyte concentration (such as a potassium ion, a sodium ion, a chloride ion, etc.), there have been known various methods such as a precipitation method using a precipitation reagent and a titrimetric and colorimetric method using a chelating reagent and colorimetric reagent. Among these, an electrode method using an ion selective electrode (ISE) is one of methods for measuring ion concentration used in many fields today, since the method enables easy and accurate measurement of metal ion concentration in solution with a good repeatability. An electrode method is a method, for example, using an Ag/AgCl electrode as a working electrode and coating the surface of AgCl with a sensitive membrane including an ionophore selectively responsive to a specific ion, thereby making a sensor. By changing an ionophore added to a sensitive membrane according to an ion to be measured, various ions can be measured. This measuring method has a characteristic that automation and miniaturization are relatively easy, since the ion concentration in a sample can be quantified by just immersing the electrode in the sample solution together with a reference electrode. Therefore, ion sensors using ISE are positively used for measurement of electrolyte concentration in blood.

In ISFET (Ion Selective Field Effect Transistor), a sensitive membrane having been used in ISE is coated on a gate electrode of FET (Field Effect transistor). In recent years, a measuring method of electrolyte concentration using ISFET as a sensor has been attracting attention. Since the ISFET sensor uses a semiconductor FET as a working electrode, it is easy to handle the sensor itself compared with the ISE sensor. In addition, it is possible to respond easily to such a form to “measure on site” or the like by setting the ISFET sensor at bedside in an urgent medical setting. Further, mass production is possible, so reduction in production costs can be expected, thereby being able to easily respond to a particularly high demand for disposability of a sensor in the medical equipment field.

In the abovementioned electrodes such as an ISE sensor and ISFET sensor, it is a sensitive membrane coated on the surface of the working electrode that actually detects ions. It is known that the sensor performance heavily depends not only on the physical shape such as thickness of the coated sensitive membrane itself, but on chemical properties such as kinds of agents included in the sensitive membrane and the mixing ratio of agents.

As an example of a sensitive membrane using an ionophore, one using a sol-gel sensitive membrane so as to prevent leakage of ionophores from the sensitive membrane is used.

### SUMMARY OF THE INVENTION

A sensitive membrane of an embodiment for an ion selective electrode selectively responsive to Na⁺ ion, the sensitive membrane comprising an ionophore, an anion exclusion agent, a plasticizer and a membrane matrix, wherein the amount of the ionophore is from 85 wt % to 95 wt % based on the mixed amount of the ionophore and the anion exclusion agent.

### BRIEF DESCRIPTION OF THE DRAWINGS

FIG. 1 shows the results of the Nernst response in accordance with a first embodiment.

FIG. 2 shows the results of the selectivity coefficient in accordance with the first embodiment.

### DETAILED DESCRIPTION

Embodiments of the present invention will be described below with reference to drawings.

A sensitive membrane of an embodiment for an ion selective electrode selectively responsive to Na⁺ ion, the sensitive membrane comprising an ionophore, an anion exclusion agent, a plasticizer and a membrane matrix, wherein the amount of the ionophore is from 85 wt % to 95 wt % based on the mixed amount of the ionophore and the anion exclusion agent.

(First Embodiment)

A sensitive membrane for an ion selective electrode in accordance with a first embodiment of the present invention is to be described.

A sensitive membrane for an ion selective electrode in accordance with the present embodiment mainly includes an ionophore, an anion exclusion agent, a plasticizer and a membrane matrix.

These are dissolved in an organic solvent such as THF (tetrahydrofuran) and the solvent of the resulting solution is volatilized in an appropriate vessel to form (cast) a film, thereby forming a sensitive membrane.

The sensitive membrane formed may be coated on an Ag/AgCl electrode or a gate electrode of FET after being casted. The solution may also be casted after being coated on an Ag/AgCl electrode or a gate electrode of FET.

An ionophore in the sensitive membrane functions to respond selectively to a specific ion in a solution to be measured. Examples of the ionophore include calixarene ionophores and crown ether ionophores. Examples of the calixarene ionophores include 4-tert-Butylcalix [4] arene-tetraacetic acid tetraethyl ester (the following formula 1).

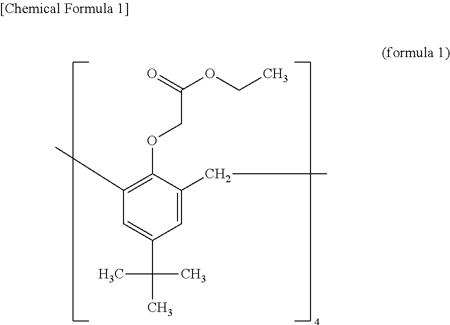

Crown ether ionophores are derivatives of crown ether compounds which are cyclic compounds and have been practically applied as ionophores for a sodium ion selective electrode. In particular, bis-12-crown-4 derivatives have been used.

An anion exclusion agent functions to interfere with incorporation of anions into the sensitive membrane for an ion selective electrode. Examples of the anion exclusion agent include TFBP (Tetrakis [3, 5-bis (trifluoromethyl) phenyl] borate, sodium salt) and Na-TBP (Tetraphenylborate, sodium salt).

A plasticizer functions to soften the sensitive membrane for an ion selective electrode. Examples of the plasticizer include NPOE (2-nitrophenyloctyl ether).

A membrane matrix functions to keep the shape of the sensitive membrane for an ion selective electrode. Examples of the membrane matrix include PVC (polyvinyl chloride).

When the amount of the plasticizer is large, the fluidity of the membrane becomes large, causing difficulty in forming the membrane. When the amount of the plasticizer is small, the softness of the membrane formed is insufficient, resulting in the membrane easy todegradate. Thus it is preferable that the weight of the plasticizer be one to three times (ex. two times) of weight of the membrane matrix upon preparing the sensitive membrane for an ion selective electrode.

In the sensitive membrane for an ion selective electrode of the present embodiment, it is preferable that the amount of the ionophore be from 85 wt % to 95 wt % based on the mixed amount of the ionophore and the anion exclusion agent.

By using the sensitive membrane for an ion selective electrode in accordance with the present embodiment, a specific ion can be efficiently measured.

(Example 1)

The Nernst response and selectivity coefficient to Na³⁰ ion were measured using the sensitive membrane for an ion selective electrode described in the first embodiment. The performance of a sensitive membrane for an ion selective electrode is determined by two indexes, the Nernst response and selectivity coefficient. That is, when both of the excellent Nernst response and excellent selectivity coefficient are exhibited, the sensitive membrane for an ion selective electrode is excellent.

Several sensitive membranes for an ion selective electrode were prepared by varying the added amount of 4-tert-Butylcalix [4] arene-tetraacetic acid tetraethyl ester (the following formula 1):

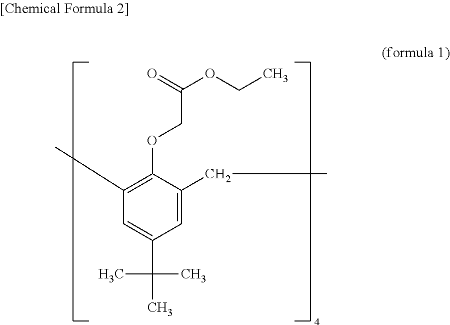

(ionophore) and Na-TBP (anion exclusion agent) and by making the amount of the ionophore to be from 70 wt % to 99 wt % based on the mixed amount of the ionophore and the anion exclusion agent. The ionophore was added by 0.2 g to 4 g and the anion exclusion agent was added by 3.7 g to 33.3 g.

As indexes that indicates properties of a sensitive membrane for an ion selective electrode, the Nernst response and selectivity coefficient are used. Evaluation was conducted in accordance with the method prescribed in the Japanese Industrial Standard JIS-K-0122 “General rules for ion selective electrode method”. Hereinafter, the evaluation methods and the like will be described specifically.

<The Nernst Response>

The Nernst response refers to a degree of coincidence with a Nernst slope given by the Nernst equation describing an electric potential of an electrode as shown in the following equation 1. A higher degree of coincidence indicates more sufficient sensitivity.

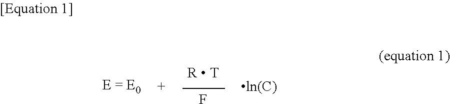

E₀ is standard potential (V), R is the gas constant (J/mol), F is Faraday's constant, T is temperature (K) and C is solution concentration (mol).

The Nernst slope is RT/F. In the present example, T was 298.15 K.

When evaluating the Nernst slope, NaCl was diluted with H₂O at 298.15 K to prepare NaCl solutions having concentrations of 1 mol/L to 1×10⁻⁵ mol/L. In the NaCl solution prepared, a reference electrode using a KCl saturated solution as an inner solution and an ISFET ion sensor in which the sensitive membrane for an ion selective electrode prepared using the method described in the first embodiment was coated on a FET gate electrode with the thickness thereof being about 70 μm were immersed. NaCl concentrations and electric potentials between the reference electrode and the ion sensor were plotted and the slope was calculated using the least squares method.

Electric potentials between the reference electrode and the ion sensor were measured by using the commercially available FET SENSOR DRIVER MODEL342 manufactured by APPLE ELECTRONICS CORP.

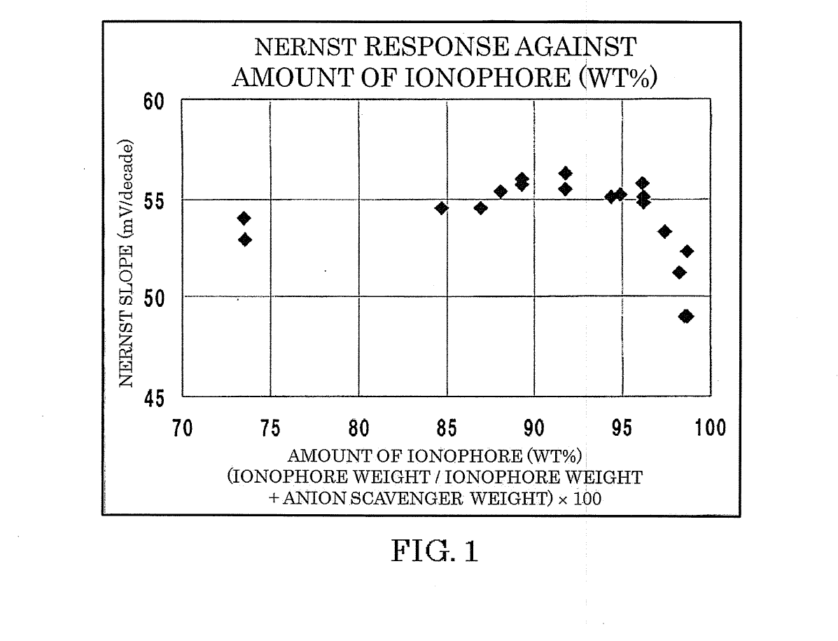

FIG. 1 shows the results plotting the change in the Nernst slope against the amount of the ionophore. The horizontal axis represents the amount of the ionophore based on the mixed amount of the ionophore and the anion exclusion agent (wt %). The longitudinal axis represents the Nernst slope (mV/decade).

The theoretical Nernst response is 59.16 mV/decade at 298.15 K.

Generally, when the theoretical Nernst response is considered to be 100%, an experimental result of 70% or more indicates a good sensitivity.

When the theoretical Nernst response at 298.15 K (59.16 mV/decade) is considered to be 100%, the results obtained by the present example are 77% to 95% based on the theoretical Nernst response, which indicates a good sensitivity.

<Selectivity Coefficient>

A selectivity coefficient is an index showing a measurement limit in such a state that a certain amount of interfering ions (coexisting ions) are included. A smaller value indicates possibility of measurement even at low concentration.

Upon evaluating the selectivity coefficient, NaCl solutions having concentrations of 1 mol/L to 1×10⁻⁵ mol/L were prepared by dilution with a 0.1 mol/L KCl solution with K⁺ being a interfering ion (coexisting ion). In the NaCl solution, a reference electrode using a KCl saturated solution as an inner solution and an ISFET sensor in which the sensitive membrane for an ion selective electrode prepared by the procedure of the first embodiment was coated on a FET gate electrode with the thickness thereof being 70 μm were immersed in the same manner as in evaluation of the Nernst slope. NaCl concentrations and potential responses between the reference electrode and the ion sensor were plotted.

Further, an ion concentration to be measured Cₓ mol/L was calculated by the intersection point between an extension line of a linear portion in such a concentration range that a response potential does not change by the influence of an interfering ion (coexisting ion) and an extension line of a linear portion in such a concentration range that a response potential changes in proportion to an ion concentration to be measured. Accordingly, the selectivity coefficient S was determined by the following equation 2.

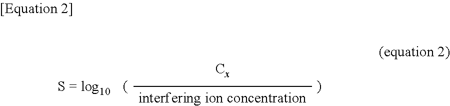

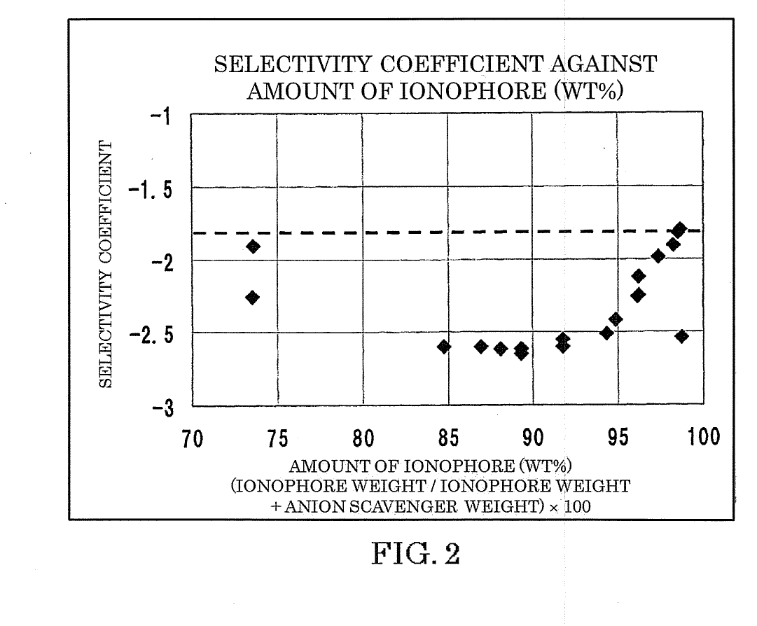

FIG. 2 shows the results plotting the change in the selectivity coefficient against the amount of the ionophore. The horizontal axis represents the amount of the ionophore based on the mixed amount of the ionophore and the anion exclusion agent (wt %). The longitudinal axis represents the selectivity coefficient.

Generally, when measuring Na⁺, the selectivity coefficient is about −1.8 (see, for example, a reference document 1: Na⁺-Ka⁺-Cl⁻ automatic electrolyte analyzer, SERA-520, July 1999, No.3, pages 25-32; HORIBA, Ltd.). A dashed line on FIG. 2 shows this.

Compared with this dashed line, it is understood that the selectivity coefficient remarkably decreases to −2.4 or less in such a, range that the amount of the ionophore is from 85 wt % to 95 wt % based on the mixed amount of the ionophore and the anion exclusion agent.

This is considered to be because the decrease in the amount of the ionophore (the amount of the ionophore is less than 85 wt %.) results in incapability of responding selectively to a specific ion in a solution.

This is also considered to be because when the amount of the ionophore is equal to or more than a certain amount (the amount of the ionophore is more than 95 wt %.), the ionophore molecule itself blocks the hole portion which selectively holds a metal ion which fits the cavity diameter of the ionophore.

Therefore, the excellent Nernst response and selectivity coefficient against the amount of the ionophore are exhibited, when the amount of the ionophore is from 85 wt % to 95 wt % based on the mixed amount of the ionophore and the anion exclusion agent. That is, it is understood that when the amount of the ionophore is from 85 wt % to 95 wt % based on the mixed amount of the ionophore and the anion exclusion agent, an excellent sensitive membrane for an ion selective electrode can be obtained.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claim is:

1. A sensitive membrane for an ion selective electrode selectively responsive to Na⁺ ion, the sensitive membrane comprising an ionophore, an anion exclusion agent, a plasticizer and a membrane matrix,
wherein the amount of the ionophore is from 85 wt % to 95 wt % based on the mixed amount of the ionophore and the anion exclusion agent.

2. The membrane according to claim 1, wherein the ionophore is calixarene ionophore or crown ether ionophore.

3. The membrane according to claim 1, wherein the ionophore is 4-tert-Butylcalix [4] arene-tetraacetic acid tetraethyl ester.

4. The membrane according to claim 1, wherein the ionophore is bis-12-crown-4 derivatives.

5. The membrane according to claim 1, wherein the anion exclusion agent is Tetraphenylborate, sodium salt or Tetrakis [3, 5-bis (trifluoromethyl) phenyl] borate, sodium salt.

6. The membrane according to claim 1, wherein a weight of the plasticizer be one to three times of weight of the membrane matrix.

7. The membrane according to claim 1, wherein the plasticizer is 2-nitrophenyloctyl ether.

8. The membrane according to claim 1, wherein the membrane matrix is polyvinyl chloride.

9. The membrane according to claim 1, wherein a Nernst response of the membrane is 77% to 95 based on the theoretical Nernst response, the theoretical Nernst response at 298.15 K (59.16 mV/decade) is considered to be 100%.
